(19) United States
(12) Patent Application Publication
(10) Pub. No.: US 2024/0359686 A1
(43) Pub. Date: Oct. 31, 2024

(54) INFORMATION PROCESSING DEVICE, INFORMATION PROCESSING METHOD, AND STORAGE MEDIUM

(71) Applicants: TOYOTA JIDOSHA KABUSHIKI KAISHA, Toyota-shi (JP); ADVICS CO., LTD., Kariya-shi (JP)

(72) Inventors: Yoshihisa YAMADA, Nagoya-shi (JP); Yosuke KIMURA, Nisshin-shi (JP); Kentaroh NAGAYA, Toyota-shi (JP); Tomoya TANAKA, Kariya-shi (JP); Yasufumi ENAMI, Kariya-shi (JP)

(73) Assignees: TOYOTA JIDOSHA KABUSHIKI KAISHA, Toyota-shi (JP); ADVICS CO., LTD., Kariya-shi (JP)

(21) Appl. No.: 18/599,772

(22) Filed: Mar. 8, 2024

(30) Foreign Application Priority Data
Apr. 28, 2023 (JP) 2023-074383

(51) Int. Cl. B60W 30/10; B60W 50/14

(52) U.S. Cl. CPC B60W 30/10; B60W 50/14; B60W 2520/10; B60W 2520/28; B60W 2720/106

(57) ABSTRACT

An information processing device includes a processor. The processor receives a requested acceleration as one of motion requests for a vehicle from each of sets of application software. The processor performs arbitration of requested accelerations that are received. The processor outputs an instruction signal for controlling an actuator of the vehicle based on a target acceleration that is a result of the arbitration of the requested accelerations. The processor acquires a detection value from an acceleration sensor installed in the vehicle. The processor performs first determination processing to determine whether an external impact has been applied to the vehicle, based on the target acceleration in addition to the detection value.

### CROSS-REFERENCE TO RELATED APPLICATION

This application claims priority to Japanese Patent Application No. 2023-074383 filed on Apr. 28, 2023, incorporated herein by reference in its entirety.

### BACKGROUND

### 1. Technical Field

The present disclosure relates to an information processing device, an information processing method, and a storage medium.

### 2. Description of Related Art

A vehicle according to Japanese Unexamined Patent Application Publication No. 2005-075315 (JP 2005-075315 A) includes a plurality of wheels, a plurality of acceleration sensors, and a control device. An acceleration sensor is a sensor for detecting acceleration that is applied to a wheel. Such an acceleration sensor includes, for example, a plurality of magnets and a sensor main unit. Each magnet is attached to the wheel. Also, the magnets are disposed arrayed in a circumferential direction of the wheel. The sensor main unit is attached to a suspension part or the like. When the wheel rotates, the sensor main unit detects rotational speed of the wheel based on changes in magnetic flux due to rotation of the magnets. The control device calculates the acceleration applied to the wheel based on the rotational speed of the wheel detected by the sensor main unit. As a result, the control device can acquire the acceleration applied to the wheel as a value detected by the acceleration sensor. The control device also determines whether the detection value that is acquired exceeds a threshold that is set in advance. When the detection value that is acquired exceeds the threshold value that is set in advance, the control device then determines that an impact has been applied to the wheel.

Even when the detected value of the acceleration sensor in a vehicle is great, this does not necessarily mean that an external impact has been applied to the vehicle. For example, when the vehicle suddenly accelerates, the detected value of the acceleration sensor changes. In this case, the vehicle is travelling normally, and accordingly no external impact has been applied to the vehicle. In other words, there is a likelihood that accurate determination that an external impact has been applied to the vehicle cannot be made, based solely on the detected value of the acceleration sensor, as in the control device according to JP 2005-075315 A.

### SUMMARY

According to an aspect of the present disclosure, an information processing device includes one or more processors. The one or more processors are configured to receive a requested acceleration as one of motion requests for a vehicle from each of sets of application software, perform arbitration of requested accelerations that are received, output an instruction signal to a control device for controlling an actuator of the vehicle based on a target acceleration that is a result of the arbitration of the requested accelerations, acquire a detection value from an acceleration sensor installed in the vehicle, and perform first determination processing to determine whether an external impact is applied to the vehicle, based on the target acceleration in addition to the detection value.

According to another aspect of the present disclosure, a non-transitory storage medium stores instructions. The instructions are executable by one or more processors of an information processing device, and cause the one or more processors to perform functions. The functions include receiving a requested acceleration as one of motion requests for a vehicle from each of sets of application software, performing arbitration of requested accelerations that are received, outputting an instruction signal to a control device for controlling an actuator of the vehicle based on a target acceleration that is a result of the arbitration of the requested accelerations, acquiring a detection value from an acceleration sensor installed in the vehicle, and performing first determination processing to determine whether an external impact is applied to the vehicle, based on the target acceleration in addition to the detection value.

According to yet another aspect of the present disclosure, an information processing method of an information processing device includes receiving a requested acceleration as one of motion requests for a vehicle from each of sets of application software, performing arbitration of requested accelerations that are received, outputting an instruction signal for controlling an actuator of the vehicle based on a target acceleration that is a result of the arbitration of the requested accelerations, acquiring a detection value from an acceleration sensor installed in the vehicle, and performing first determination processing to determine whether an external impact is applied to the vehicle, based on the target acceleration in addition to the detection value.

According to the above configuration, not only magnitude of the acceleration actually detected, but also magnitude of the acceleration to be detected in accordance with the movement being requested of the vehicle, is taken into account when determining whether an external impact has been applied to the vehicle. Thus, precision of determining external impact on the vehicle can be improved.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic configuration diagram of an information processing system;

FIG. 2 is a functional block diagram illustrating a basic configuration of a motion manager; and

FIG. 3 is a flowchart showing determination control.

### DETAILED DESCRIPTION OF EMBODIMENTS SCHEMATIC CONFIGURATION OF INFORMATION PROCESSING SYSTEM

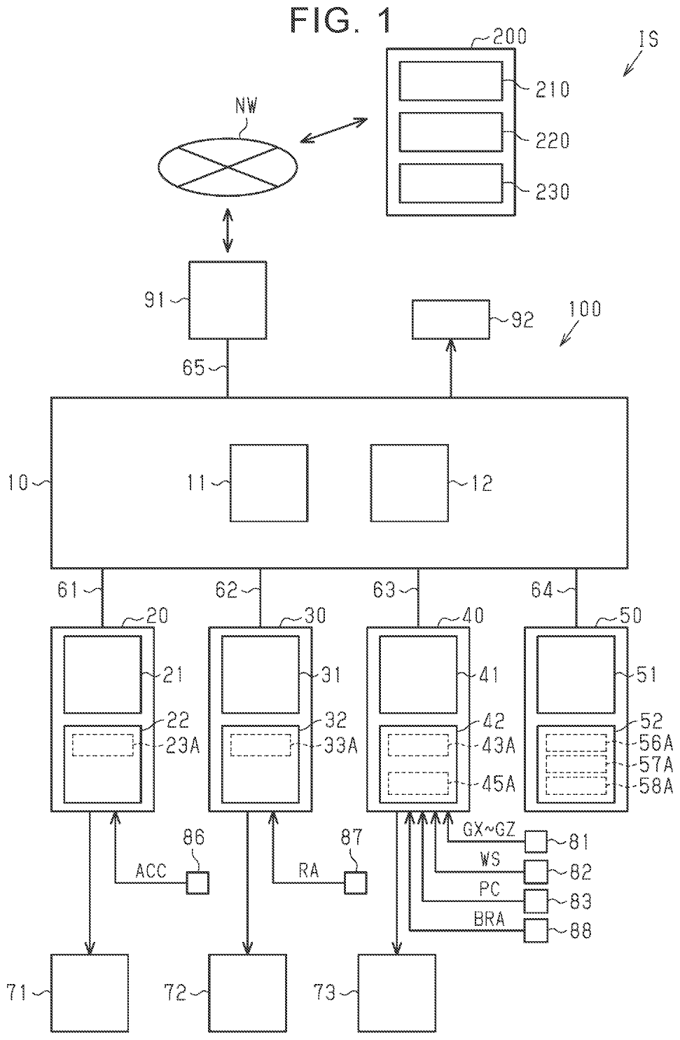

An embodiment of the present disclosure will be described below with reference to FIGS. 1 to 3. First, a schematic configuration of an information processing system IS will be described.

As illustrated in FIG. 1, the information processing system IS includes a vehicle 100. The vehicle 100 includes a powertrain device 71, a steering system 72, and a brake device 73.

The powertrain device 71 includes an engine, a motor generator, and a transmission. The engine can apply driving force to drive wheels of the vehicle 100 via the transmission. Also, the motor generator can apply driving force to the drive wheels of the vehicle 100 via the transmission.

An example of the steering system 72 is a rack and pinion electric steering system. The steering system 72 can change orientation of steered wheels of the vehicle 100 by controlling a rack and a pinion, omitted from illustration.

The brake device 73 is a so-called mechanical brake device that mechanically brakes the wheels of the vehicle 100. In the present embodiment, an example of the brake device 73 is a disc brake.

As illustrated in FIG. 1, the vehicle 100 includes a central ECU 10, a powertrain ECU 20, a steering ECU 30, a brake ECU 40, and an advanced driver assistance ECU 50. The vehicle 100 also includes a first external bus 61, a second external bus 62, a third external bus 63, a fourth external bus 64, and a fifth external bus 65. Note that the term “ECU” is an abbreviation for “electronic control unit.”

The central ECU 10 centrally controls the overall vehicle 100. The central ECU 10 includes an execution device 11 and a storage device 12. An example of the execution device 11 is a central processing unit (CPU). The storage device 12 includes read-only memory (ROM) that can only be read, volatile random access memory (RAM) that can be read and written, and nonvolatile storage that can be read and written. The storage device 12 stores various types of programs and various types of data in advance. The execution device 11 realizes various types of processing by executing the programs stored in the storage device 12.

The powertrain ECU 20 is capable of mutual communication with the central ECU 10 via the first external bus 61. The powertrain ECU 20 controls the powertrain device 71 by outputting control signals to the powertrain device 71. The powertrain ECU 20 includes an execution device 21 and a storage device 22. An example of the execution device 21 is a CPU. The storage device 22 includes ROM, RAM, and storage. The storage device 22 stores various types of programs and various types of data in advance. The storage device 22 also stores a powertrain application 23A as one of the various types of programs in advance. The powertrain application 23A is application software for controlling the powertrain device 71. The execution device 21 realizes a function as a powertrain control unit 23, which will be described later, by executing the powertrain application 23A stored in the storage device 22.

The steering ECU 30 can communicate with the central ECU 10 via the second external bus 62. The steering ECU 30 controls the steering system 72 by outputting control signals to the steering system 72. The steering ECU 30 includes an execution device 31 and a storage device 32. An example of the execution device 31 is a CPU. The storage device 32 includes ROM, RAM, and storage. The storage device 32 stores various types of programs and various types of data in advance. The storage device 32 also stores a steering application 33A as one of the various types of programs in advance. The steering application 33A is application software for controlling the steering system 72. The execution device 31 realizes a function as a steering control unit 33, which will be described later, by executing the steering application 33A stored in the storage device 32.

The brake ECU 40 can communicate with the central ECU 10 via the third external bus 63. The brake ECU 40 controls the brake device 73 by outputting control signals to the brake device 73. The brake ECU 40 includes an execution device 41 and a storage device 42. An example of the execution device 41 is a CPU. The storage device 42 includes ROM, RAM, and storage. The storage device 42 stores various types of programs and various types of data in advance. The storage device 42 also stores a brake application 43A as one of the various types of programs in advance. The brake application 43A is application software for controlling the brake device 73. The storage device 42 further stores a motion manager application 45A as one of the various types of programs in advance. The motion manager application 45A is application software for performing arbitration regarding a plurality of motion requests. The execution device 41 realizes a function as a brake control unit 43, which will be described later, by executing the brake application 43A stored in the storage device 42. The execution device 41 also realizes a function as a motion manager 45, which will be described later, by executing the motion manager application 45A stored in the storage device 42. In the present embodiment, the brake ECU 40 is an information processing device. Also, the motion manager application 45A is an information processing program. That is to say, the execution device 41 of the brake ECU 40 executes various types of processing in an information processing method by executing the motion manager application 45A.

The advanced driver assistance ECU 50 is capable of mutual communication with the central ECU 10 via the fourth external bus 64. The advanced driver assistance ECU 50 executes various types of driver assistance. The advanced driver assistance ECU 50 includes an execution device 51 and a storage device 52. An example of the execution device 51 is a CPU. The storage device 52 includes ROM, RAM, and storage. The storage device 52 stores various types of programs and various types of data in advance. The various types of programs include a first assistance application 56A, a second assistance application 57A, and a third assistance application 58A. An example of the first assistance application 56A is application software for collision damage mitigation braking, which is so-called autonomous emergency braking (AEB), that automatically applies braking in order to mitigate damage of a collision to the vehicle 100. An example of the second assistance application 57A is application software for so-called lane keeping assist (LKA) that maintains the lane in which the vehicle 100 is traveling. An example of the third assistance application 58A is application software for so-called automatic driving, which enables the vehicle 100 to travel automatically without any operations by a driver of the vehicle 100. In the present embodiment, the first assistance application 56A, the second assistance application 57A, and the third assistance application 58A are each application software that realizes driver assistance functions of the vehicle 100. The execution device 51 realizes a function as a first assistance unit 56, which will be described later, by executing the first assistance application 56A stored in the storage device 52. The execution device 51 also realizes a function as a second assistance unit 57, which will be described later, by executing the second assistance application 57A stored in the storage device 52. The execution device 51 realizes a function as a third assistance unit 58, which will be described later, by executing the third assistance application 58A stored in the storage device 52.

As illustrated in FIG. 1, the vehicle 100 includes an acceleration sensor 81, a wheel speed sensor 82, and a GNSS receiver 83. The vehicle 100 also includes an accelerator operation amount sensor 86, a steering angle sensor 87, and a brake operation amount sensor 88.

The acceleration sensor 81 is a so-called three-axis sensor. That is to say, the acceleration sensor 81 can detect a longitudinal acceleration GX, a lateral acceleration GY, and a vertical acceleration GZ. The longitudinal acceleration GX is acceleration along a longitudinal axis of the vehicle 100. The lateral acceleration GY is acceleration along a lateral axis of the vehicle 100. The vertical acceleration GZ is acceleration along a vertical axis of the vehicle 100.

The wheel speed sensor 82 detects a wheel speed WS that is the rotational speed of a wheel of the vehicle 100. The wheel speed sensor 82 is positioned near each wheel of the vehicle 100. In the present embodiment, the vehicle 100 includes four wheel speed sensors 82 in correspondence with the four wheels that the vehicle 100 is equipped with. Note that in FIG. 1, just one wheel speed sensor 82 is illustrated representatively.

The GNSS receiver 83 detects position coordinates PC, which are coordinates of a point where the vehicle 100 is located, through communication with GNSS satellites that are omitted from illustration. Note that the term “GNSS” is an abbreviation for “Global Navigation Satellite System.”

The accelerator operation amount sensor 86 detects an accelerator operation amount ACC that is an operation amount of an accelerator pedal operated by the driver. The steering angle sensor 87 detects a steering angle RA, which is an angular position of a steering shaft operated by the driver. The brake operation amount sensor 88 detects a brake operation amount BRA that is an operation amount of a brake pedal operated by the driver.

The powertrain ECU 20 acquires signals indicating the accelerator operation amount ACC from the accelerator operation amount sensor 86. The steering ECU 30 acquires signals indicating the steering angle RA from the steering angle sensor 87. The brake ECU 40 acquires signals indicating the longitudinal acceleration GX, the lateral acceleration GY, and the vertical acceleration GZ from the acceleration sensor 81. The brake ECU 40 also acquires signals indicating the position coordinates PC from the GNSS receiver 83. The brake ECU 40 acquires signals indicating four wheel speeds WS from the four wheel speed sensors 82. The brake ECU 40 acquires signals indicating the brake operation amount BRA from the brake operation amount sensor 88. Note that the brake ECU 40 can acquire various types of values, including the accelerator operation amount ACC and the steering angle RA, via the central ECU 10.

The brake ECU 40 calculates a vehicle speed SP that is the speed of the vehicle 100 in each control cycle set in advance. For example, the brake ECU 40 calculates the vehicle speed SP by multiplying an average value of the four wheel speeds WS by a coefficient that is set in advance.

As illustrated in FIG. 1, the vehicle 100 includes a DCM 91 and a display 92. The DCM 91 is connected to the central ECU 10 via the fifth external bus 65. The DCM 91 can wirelessly communicate with equipment outside the vehicle 100 via a communication network NW. Note that the term “DCM” is an abbreviation for “Data Communication Module”. The display 92 is connected to the central ECU 10. The display 92 can display various types of information based on image data output from the central ECU 10.

As illustrated in FIG. 1, the information processing system IS includes a data center 200. An example of the data center 200 is a so-called server. The data center 200 includes an execution unit 210, a storage unit 220, and a communication unit 230. The communication unit 230 can communicate with equipment outside the data center 200 via the communication network NW.

### Basic Configuration Related to Motion Manager

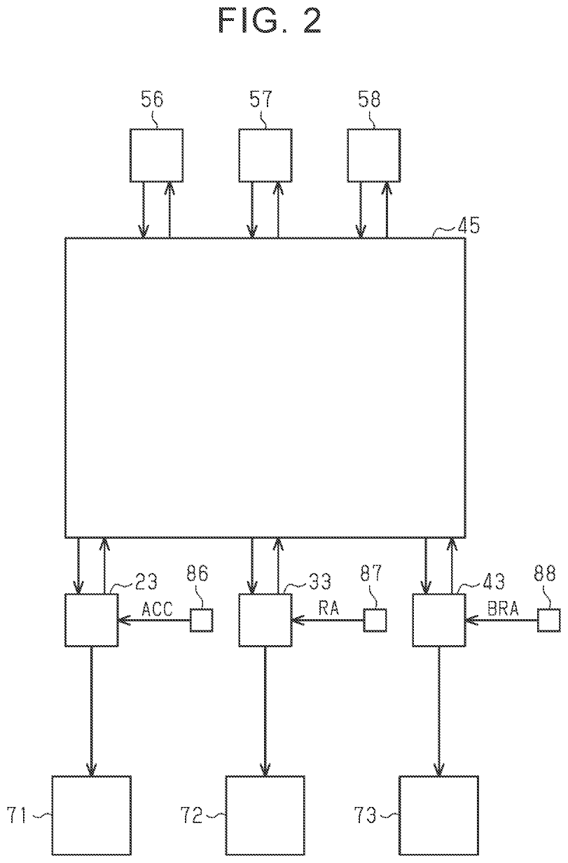

Next, a basic configuration related to the motion manager 45 will be described with reference to FIG. 2. As illustrated in FIG. 2, the motion manager 45 can mutually communicate with the first assistance unit 56, the second assistance unit 57, and the third assistance unit 58. The motion manager 45 can also mutually communicate with the powertrain control unit 23, the steering control unit 33, and the brake control unit 43.

The first assistance unit 56, the second assistance unit 57, and the third assistance unit 58 output motion requests to the motion manager 45 when executing various types of control. At this time, for example, the first assistance unit 56, the second assistance unit 57, and the third assistance unit 58 continuously output the motion requests from when the various types of control become necessary until such control is no longer needed. Now, the motion requests include a requested longitudinal acceleration GXR, and so forth, for controlling the acceleration along the longitudinal axis of the vehicle 100. In the present embodiment, the requested longitudinal acceleration GXR is an example of requested acceleration received from application software.

The motion manager 45 receives the requested longitudinal acceleration GXR as a motion request from the first assistance unit 56, the second assistance unit 57, and the third assistance unit 58. Also, the motion manager 45 performs arbitration of requested longitudinal accelerations GXR that are received. For example, when the motion manager 45 receives requested longitudinal accelerations GXR from a plurality of assistance units, the motion manager 45 selects the requested longitudinal acceleration GXR received at an earliest timing as a result of arbitration. Also, for example, when the motion manager 45 receives requested longitudinal accelerations GXR from the assistance units, the motion manager 45 selects the requested longitudinal acceleration GXR that is the smallest as a result of arbitration. The motion manager 45 thus performs arbitration of the motion requests according to a rule that is set in advance, in accordance with a driving situation of the vehicle 100. The motion manager 45 then sets the requested longitudinal acceleration GXR selected as the result of arbitration, as a target longitudinal acceleration GXT. In the present embodiment, the target longitudinal acceleration GXT corresponds to the target acceleration that is the result of arbitration of requested accelerations.

The motion manager 45 generates instruction signals for action requests to control various types of actuators based on the target longitudinal acceleration GXT. Now, the various types of actuators are the powertrain device 71, the steering system 72, and the brake device 73, and so forth. For example, when controlling the powertrain device 71, the motion manager 45 outputs an instruction signal for an action request to the powertrain control unit 23. The powertrain control unit 23 then outputs a control signal to the powertrain device 71 based on the instruction signal of the action request. In this way, the instruction signal output by the motion manager 45 is received by the control unit corresponding to the actuator to be controlled. The actuator is controlled by the control unit.

Each of the powertrain control unit 23, the steering control unit 33, and the brake control unit 43 can receive an instruction signal for an action request from the driver of the vehicle 100, in addition to an instruction signal for an action request from the motion manager 45. When receiving an instruction signal for an action request from the driver of the vehicle 100, the powertrain control unit 23, the steering control unit 33, and the brake control unit 43 output a control signal to the actuators, based on the instruction signal for the action request from the driver of the vehicle 100. That is to say, when receiving an instruction signal for an action request from the driver of the vehicle 100, each control unit invalidates the instruction signals for action requests from the motion manager 45. Note that the powertrain control unit 23 can receive the accelerator operation amount ACC from the accelerator operation amount sensor 86 as an instruction signal for an action request, for controlling the actuator based on operations of the driver. Also, the steering control unit 33 can receive the steering angle RA from the steering angle sensor 87 as an instruction signal for an action request for controlling the actuator based on operations of the driver. Further, the brake control unit 43 can receive the brake operation amount BRA from the brake operation amount sensor 88 as an instruction signal for an action request for controlling the actuator based on operations of the driver.

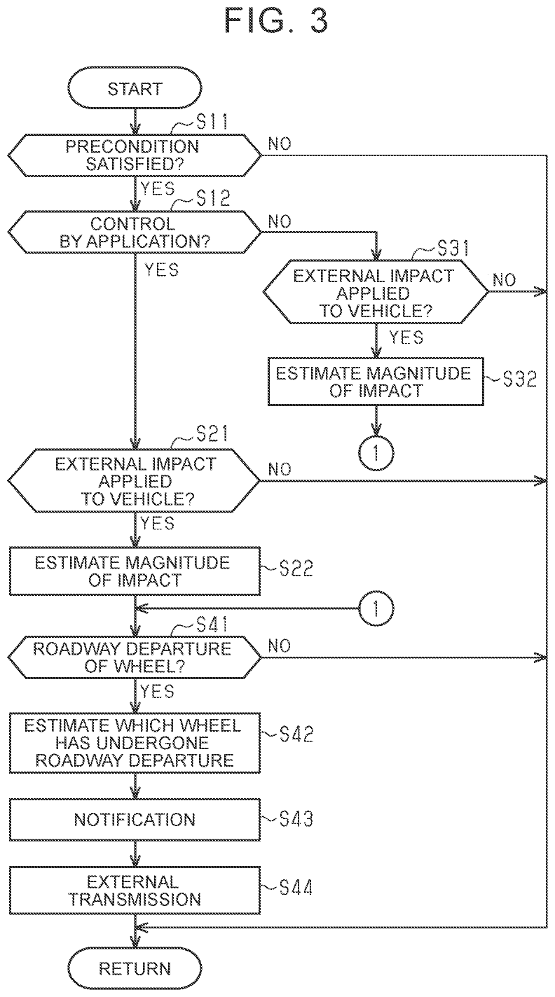

Next, determination control executed by the motion manager 45 will be described with reference to FIG. 3. In the present embodiment, the motion manager 45 repeatedly executes the determination control on the condition that the vehicle 100 is traveling.

When the determination control is started, as shown in FIG. 3, the motion manager 45 executes the processing of step S11. In step S11, the motion manager 45 determines whether a precondition set in advance is satisfied. Here, the precondition is a condition for detecting a situation in which the vehicle 100 starts traveling, such as the vehicle 100 entering a road from a parking lot, for example. In this embodiment, the precondition is that the vehicle speed SP is no greater than a stipulated vehicle speed that is set in advance. An example of the stipulated vehicle speed is around several kilometers per hour to 10-something kilometers per hour. When the motion manager 45 determines in step S11 that the precondition is not satisfied (NO in S11), the motion manager 45 ends the current determination control. The motion manager 45 then advances the processing to step S11 again. On the other hand, when the motion manager 45 determines in step S11 that the precondition is satisfied (S11: YES), the motion manager 45 advances the processing to step S12. In other words, the motion manager 45 advances the processing to step S12 only when the vehicle speed SP is no greater than the stipulated vehicle speed set in advance.

In step S12, the motion manager 45 determines whether the actuators are being controlled by application software. Specifically, the motion manager 45 determines whether the actuators are being controlled based on the target longitudinal acceleration GXT corresponding to a motion request received from the application software. For example, when the powertrain device 71, the steering system 72, and the brake device 73 are all controlled based on the target longitudinal acceleration GXT, the motion manager 45 determines that the actuators are being controlled based on the target longitudinal acceleration GXT. On the other hand, when one or more of the powertrain device 71, the steering system 72, and the brake device 73 is being controlled based on operations of the driver of the vehicle 100, the motion manager 45 determines that the actuators are not being controlled based on the target longitudinal acceleration GXT. In step S12, when the motion manager 45 determines that the actuators are being controlled by the application software (YES in S12), the motion manager 45 advances the processing to step S21. In other words, the motion manager 45 advances the processing to step S21 on the condition that the actuators are being controlled based on the target longitudinal acceleration GXT.

In step S21, the motion manager 45 determines whether an external impact has been applied to the vehicle 100, based on the longitudinal acceleration GX and the target longitudinal acceleration GXT. Specifically, the motion manager 45 determines that an external impact has been applied to the vehicle 100 when an absolute value of difference between the longitudinal acceleration GX and the target longitudinal acceleration GXT is no less than a first stipulated value A that is set in advance. Here, the first stipulated value A is a threshold value for determining whether the absolute value of the difference between the longitudinal acceleration GX and the target longitudinal acceleration GXT is unacceptably great. Accordingly, for example, when the target longitudinal acceleration GXT is a positive value, i.e., when the vehicle 100 is in a situation of attempting to accelerate, but the longitudinal acceleration GX is a negative value, i.e., the vehicle 100 is decelerating, or the like, the motion manager 45 determines that an external impact has been applied to the vehicle 100. In the present embodiment, the processing of step S21 is first determination processing. When the motion manager 45 determines in step S21 that no external impact has been applied to the vehicle 100 (NO in S21), the motion manager 45 ends the current determination control. The motion manager 45 then advances the processing to step S11 again. On the other hand, when the motion manager 45 determines in step S21 that an external impact has been applied to the vehicle 100 (YES in S21), the motion manager 45 advances the processing to step S22.

In step S22, the motion manager 45 estimates an impact value GA, which is a magnitude of the impact applied to the vehicle 100, based on the longitudinal acceleration GX and the target longitudinal acceleration GXT. Specifically, the motion manager 45 estimates the absolute value of the difference between the longitudinal acceleration GX and the target longitudinal acceleration GXT as the impact value GA. After step S22, the motion manager 45 advances the processing to step S41.

On the other hand, when the motion manager 45 determines in the above-described step S12 that the actuators are not being controlled by the application software (NO in S12), the motion manager 45 advances the processing to step S31. In other words, the motion manager 45 advances the processing to step S31 on the condition that the actuators are being controlled based on the operations of the driver of the vehicle 100.

In step S31, the motion manager 45 determines whether an external impact has been applied to the vehicle 100, based on the longitudinal acceleration GX. In other words, the motion manager 45 determines whether an external impact has been applied to the vehicle 100, based on the longitudinal acceleration GX, regardless of the target longitudinal acceleration GXT. Specifically, the motion manager 45 determines that an external impact has been applied to the vehicle 100 when the absolute value of the longitudinal acceleration GX is no less than a second stipulated value B that is set in advance. Here, the second stipulated value B is a threshold value for determining whether the absolute value of the longitudinal acceleration GX is unacceptably great. For example, when another vehicle collides with the vehicle 100 from behind, or a wheel of the vehicle 100 departs from the road in a roadway departure, the acceleration of the vehicle 100 can temporarily become very great. The second stipulated value B is set as a value by which such a situation can be detected. In the present embodiment, the processing of step S31 is second determination processing. When the motion manager 45 determines in step S31 that no external impact has been applied to the vehicle 100 (NO in S31), the motion manager 45 ends the current determination control. The motion manager 45 then advances the processing to step S11 again. On the other hand, when the motion manager 45 determines in step S31 that an external impact has been applied to the vehicle 100 (YES in S31), the motion manager 45 advances the processing to step S32.

In step S32, the motion manager 45 estimates the impact value GA, which is the magnitude of the impact applied to the vehicle 100, based on the longitudinal acceleration GX. Specifically, the motion manager 45 estimates the absolute value of the longitudinal acceleration GX as the impact value GA. After step S32, the motion manager 45 advances the processing to step S41.

Accordingly, in the present embodiment, when determination is made in the first determination processing of step S21 that an external impact has been applied to the vehicle 100, or determination is made in the second determination processing of step S31 that an external impact has been applied to the vehicle 100, the processing advances to step S41.

In step S41, the motion manager 45 determines whether a roadway departure of a wheel of the vehicle 100 has occurred, based on the wheel speed WS. Specifically, the motion manager 45 determines that a roadway departure of a wheel of the vehicle 100 has occurred when an absolute value of difference between maximum and minimum values of the four wheel speeds WS is no less than a reference value C that is set in advance. Here, the reference value C is set as a threshold value for determining roadway departure of a wheel through experiments, simulations, and so forth. For example, when a roadway departure of a certain wheel of the vehicle 100 occurs, reaction force exerted on that wheel from the road surface becomes smaller, so the wheel speed WS of that wheel increases. The absolute value of the difference between the greatest value and the smallest value of the four wheel speeds WS then increases. As a result, the motion manager 45 determines that the vehicle 100 has undergone a roadway departure of a wheel. Note that the term “roadway departure” as used herein refers to any situation in which some of the wheels of the vehicle 100 are not in contact with the ground, such as a wheel of the vehicle 100 falling into a trench or the like that is present near the road, for example. When the motion manager 45 determines in step S41 that the vehicle 100 is not undergoing roadway departure of a wheel, (NO in S41), the motion manager 45 ends the current determination control. The motion manager 45 then advances the processing to step S11 again. On the other hand, when the motion manager 45 determines in step S41 that the vehicle 100 is undergoing roadway departure of a wheel (YES in S41), the motion manager 45 advances the processing to step S42.

In step S42, the motion manager 45 determines which wheel has undergone the roadway departure, based on the wheel speeds WS. Specifically, the motion manager 45 estimates the wheel corresponding to the greatest wheel speed WS among the four wheel speeds WS as being the wheel that has undergone the roadway departure. The motion manager 45 also stores information, indicating the cumulative number of times that roadway departure has occurred for each wheel, in the storage device 42. After step S42, the motion manager 45 advances the processing to step S43.

In step S43, the motion manager 45 notifies the user of the vehicle 100 that an external impact has been applied to the vehicle 100. Specifically, the motion manager 45 notifies the user of the vehicle 100 via the display 92 by outputting control signals to the display 92. Similarly, the motion manager 45 notifies the user of the vehicle 100 that roadway departure of a wheel has occurred. Further, the motion manager 45 notifies the user of the vehicle 100 which wheel has undergone roadway departure. Also, the motion manager 45 notifies the user of the vehicle 100 of the impact value GA. After step S43, the motion manager 45 advances the processing to step S44.

In step S44, the motion manager 45 transmits determination data DI relating to the determination of the impact of the vehicle 100 to the data center 200. In the present embodiment, the determination data DI includes information regarding position coordinates PC when the vehicle 100 was subjected to the external impact, information regarding the date and time when the external impact was applied to the vehicle 100, information regarding the wheel undergoing roadway departure, and information regarding the impact value GA. Note that the information regarding the position coordinates PC when the vehicle 100 is subjected to an external impact is equivalent to position information of the point where the vehicle 100 is located when the external impact is applied to the vehicle 100. After step S44, the motion manager 45 ends the current determination control. The motion manager 45 then advances the processing to step S11 again.

### Effects of Present Embodiment

For example, assumption will be made regarding a situation in which the vehicle 100 is traveling by controlling the actuators based on the target longitudinal acceleration GXT corresponding to a motion request received from application software, such as the third assistance application 58A. When the vehicle 100 is traveling in this way, the motion manager 45 performs the determination control as shown in FIG. 3. Assumption will be further made that for example, the vehicle 100 is in a situation of entering a road from a parking lot, under control of the third assistance application 58A. Assumption will be made that, in such a situation, a drive wheel, out of the wheels of the vehicle 100, falls into a trench or the like that is present near the road, i.e., a so-called roadway departure of a drive wheel of the vehicle 100 occurs. When such a roadway departure of a wheel occurs, even in a situation in which the vehicle 100 is attempting to accelerate for example, i.e., the target longitudinal acceleration GXT is a positive value, the vehicle 100 suddenly decelerates due to the roadway departure, and the longitudinal acceleration GX becomes a negative value. As a result, the absolute value of the difference between the longitudinal acceleration GX and the target longitudinal acceleration GXT is no smaller than the first stipulated value A that is set in advance. Thus, in step S21, the motion manager 45 determines that an external impact has been applied to the vehicle 100, based on the longitudinal acceleration GX and the target longitudinal acceleration GXT.

### Advantages of Present Embodiment

(1) According to the present embodiment, in addition to the longitudinal acceleration GX, which is the detected value of the acceleration sensor 81, the target longitudinal acceleration GXT, which indicates the motion state of the vehicle 100 regarding which realizing is desired, is taken into account, and determination is made regarding whether an external impact has been applied to the vehicle 100. In other words, not only magnitude of the acceleration actually detected by the acceleration sensor 81, but also magnitude of the acceleration to be detected in accordance with the movement being requested of the vehicle 100, is taken into account when determining whether an external impact has been applied to the vehicle 100. Thereby, the precision of determining whether an external impact has been applied to the vehicle 100 can be improved.

(2) Generally, in a situation in which the vehicle 100 starts to travel, such as when the vehicle 100 enters a road from a parking lot, there is a higher likelihood that the vehicle 100 will pass near a trench or the like. Accordingly, the likelihood of a roadway departure of a wheel of the vehicle 100 tends to be higher. Therefore, in a situation in which the vehicle 100 starts to travel, such as when the vehicle 100 enters a road from a parking lot, there is a higher likelihood that an external impact will be applied to the vehicle 100 due to roadway departure of a wheel of the vehicle 100.

In the present embodiment, the motion manager 45 executes the processing of step S12 and thereafter only when the vehicle speed SP is no greater than a stipulated vehicle speed that is set in advance. The motion manager 45 then determines whether an external impact has been applied to the vehicle 100, through one of the first determination processing in step S21 and the second determination processing in step S31. In other words, only in situations where there is a high likelihood that an external impact will be applied to the vehicle 100, will one of the first determination processing in step S21 and the second determination processing in step S31 be executed. Accordingly, the processing load on the execution device 41 of the brake ECU 40 in conjunction with the determination processing can be suppressed as compared to a case in which the first determination processing in step S21 and the second determination processing in step S31 are executed regardless of the vehicle speed SP, for example.

(3) When the actuators are being controlled based on operations by the driver of the vehicle 100, for example, there is a high likelihood that the longitudinal acceleration GX and the target longitudinal acceleration GXT will not match, even though no external impact is applied to the vehicle 100. Accordingly, when determination is made regarding whether an external impact has been applied to the vehicle 100 based on the first determination processing in step S21 in the above case, i.e., on the longitudinal acceleration GX and the target longitudinal acceleration GXT, the precision of the determination tends to be lower.

In the present embodiment, the motion manager 45 advances the processing to step S21 when the actuators are being controlled by the application software, i.e., on the condition that the actuators are being controlled based on the target longitudinal acceleration GXT. The motion manager 45 then determines whether an external impact has been applied to the vehicle 100, based on the first determination processing of step S21, i.e., the longitudinal acceleration GX and the target longitudinal acceleration GXT. On the other hand, the motion manager 45 advances the processing to step S31 on the condition that the actuators are being controlled based on the operations of the driver of the vehicle 100. The motion manager 45 then determines whether an external impact has been applied to the vehicle 100, based on the second determination processing of step S31, i.e., on the longitudinal acceleration GX regardless of the target longitudinal acceleration GXT. Thus, when the actuator is controlled based on operations by the driver of the vehicle 100, lowering of the precision of determining whether an external impact has been applied to the vehicle 100 can be suppressed.

(4) The motion manager 45 advances the processing to step S22 on the condition that determination is made in the first determination processing of step S21 that an external impact has been applied to the vehicle 100. In step S22, the motion manager 45 then estimates the impact value GA, which is the magnitude of the impact applied to the vehicle 100, based on the longitudinal acceleration GX and the target longitudinal acceleration GXT. Thus, by the user or the like of the vehicle 100 being able to comprehend the impact value GA, for example, the user or the like of the vehicle 100 can easily judge the necessity of maintenance of the vehicle 100.

Note that in step S32, the motion manager 45 estimates the impact value GA, which is the magnitude of the impact applied to the vehicle 100, based on the longitudinal acceleration GX. Thus, by the user or the like of the vehicle 100 being able to comprehend the impact value GA, for example, the user or the like of the vehicle 100 can easily judge the necessity of maintenance of the vehicle 100, in the same way as above.

(5) The motion manager 45 advances the processing to step S41 on the condition that determination is made in one of the first determination processing in step S21 and the second determination processing in step S31 that an external impact has been applied to the vehicle 100. In step S41, the motion manager 45 determines whether a roadway departure of a wheel of the vehicle 100 has occurred, based on the wheel speed WS. When roadway departure of a wheel occurs, the motion manager 45 determines that the roadway departure has occurred based on the wheel speed WS. Thereby, a worker or the like who performs maintenance of the vehicle 100, for example, can easily identify the location where maintenance should be performed, by comprehending that roadway departure of a wheel has occurred.

(6) In step S42, the motion manager 45 estimates which wheel has undergone the roadway departure, based on the wheel speeds WS. By estimating the wheel at which the roadway departure occurred in this way, a worker or the like who maintains the vehicle 100, for example, can easily identify the location where maintenance should be performed in further detail by comprehending the wheel where the roadway departure has occurred.

(7) The motion manager 45 advances the processing to step S43 on the condition that determination is made in one of the first determination processing in step S21 and the second determination processing in step S31 that an external impact has been applied to the vehicle 100. In step S43, the motion manager 45 then notifies the user of the vehicle 100 that an external impact has been applied to the vehicle 100. Thus, by the user or the like of the vehicle 100 being able to comprehend that an external impact has been applied to the vehicle 100, for example, the user or the like of the vehicle 100 can easily judge the necessity of maintenance of the vehicle 100.

(8) In step S44, the motion manager 45 transmits the determination data DI relating to the determination of the impact of the vehicle 100 to the data center 200. Here, the determination data DI includes information such as the position coordinates PC when an external impact is applied to the vehicle 100, and so forth. Thus, by analyzing the information regarding collected position coordinates PC, for example, locations where impact is likely to be applied to the vehicle 100, and locations where roadway departure of a wheel of the vehicle 100 frequently occurs, can be identified.

### Modifications

The present embodiment can be carried out modified as follows. The present embodiment and the following modifications can be carried out combined with each other as long as no technical contradiction arises.

In the above embodiment, the determination control may be changed. For example, a condition for executing the determination control may be changed. As a specific example, the motion manager 45 may execute the determination control regardless of whether the vehicle 100 is traveling.

The precondition in step S11, for example, may be changed. As a specific example, in addition to or instead of the requirement that the vehicle speed SP be no greater than a stipulated vehicle speed that is set in advance, the precondition may include a requirement that a certain period of time has elapsed after the vehicle speed SP became greater than zero. Further, as a specific example, the precondition is not limited to a condition for detecting a situation in which the vehicle 100 starts traveling, such as when the vehicle 100 enters a road from a parking lot, but also a condition for detecting a situation in which the vehicle 100 ends traveling, such as when the vehicle 100 enters a parking lot from a road. That is to say, other conditions may be adopted as the preconditions in order to detect a situation in which there is a high likelihood that an external impact will be applied to the vehicle 100.

The processing in step S11 may be omitted, for example. As a specific example, the motion manager 45 may execute the processing of step S12 when starting the determination control. Note that even when the processing in step S11 is omitted, it is unlikely that the processing load on the execution device 41 of the brake ECU 40 will increase excessively.

The way in which determination is made in step S12, for example, may be changed. As a specific example, when one or more of the powertrain device 71, the steering system 72, and the brake device 73 is controlled based on the target longitudinal acceleration GXT, the motion manager 45 may determine that the actuators are being controlled based on the target longitudinal acceleration GXT. On the other hand, when the powertrain device 71, the steering system 72, and the brake device 73 are all being controlled based on operations of the driver of the vehicle 100, the motion manager 45 may determine that the actuators are not being controlled based on the target longitudinal acceleration GXT.

The way in which determination is made in step S21, for example, may be changed. As a specific example, the motion manager 45 may receive, in some situations, requested lateral acceleration to control acceleration along the lateral axis of the vehicle 100, as motion requests from the first assistance unit 56, the second assistance unit 57, and the third assistance unit 58, in addition to or instead of the requested longitudinal acceleration GXR. The motion manager 45 may then set the requested lateral acceleration selected as a result of arbitration, as the target lateral acceleration. In this case, in step S21, the motion manager 45 may determine that an external impact has been applied to the vehicle 100 when the absolute value of the difference between the lateral acceleration GY and the target lateral acceleration is no less than a stipulated value that is set in advance. Note that in the same way, in step S21, the motion manager 45 can determine that an external impact has been applied to the vehicle 100 when the absolute value of the difference between the vertical acceleration GZ and target vertical acceleration is no less than the stipulated value that is set in advance. That is to say, the target acceleration used in step S21 is not limited to the target longitudinal acceleration GXT, and may be changed.

The processing in step S22, for example, may be omitted. As a specific example, the motion manager 45 may advance the processing to step S41 when an affirmative determination is made in step S21. Note that even when the processing of step S22 is omitted, the user or the like of the vehicle 100 can still judge the necessity of maintenance of the vehicle 100 based on, for example, the impact actually experienced. In the same way, the processing in step S32 may be omitted.

The processing in step S31, for example, may be omitted. Note that even when the processing in step S31 is omitted, determination of whether an external impact has been applied to the vehicle 100 can still be executed through the processing in step S21. In this case, the motion manager 45 can advance the processing to step S21 when an affirmative determination is made in step S11. Note that in this configuration, the processing of step S12, step S31, and step S32 can be omitted.

The processing in step S42, for example, may be omitted. As a specific example, the motion manager 45 may advance the processing to step S43 when an affirmative determination is made in step S41. Note that even when the processing in step S42 is omitted, as long as determination is made in step S41 regarding whether roadway departure of a wheel of the vehicle 100 has occurred, a worker or the like who maintains the vehicle 100, for example, can identify locations that require maintenance by comprehending whether roadway departure of a wheel has occurred.

The processing in step S41, for example, may be omitted. As a specific example, the motion manager 45 may advance the processing to step S43 after step S22 or after step S32. Note that even when the processing of step S41 is omitted, determination is made in one of the processing of step S21 and step S31 regarding whether an external impact has been applied to the vehicle 100, and accordingly the user or the like of the vehicle 100 can judge the necessity of maintenance of the vehicle 100.

The contents of notification in step S43, for example, may be changed. As a specific example, the motion manager 45 may skip performing notification that an external impact has been applied to the vehicle 100, and notify the user of the vehicle 100 that roadway departure of a wheel has occurred, or the like.

The processing in step S43, for example, may be omitted. As a specific example, the motion manager 45 may advance the processing to step S44 after step S42. Note that even when the processing in step S43 is omitted, determination itself of whether an external impact has been applied to the vehicle 100 can still be executed through the processing in one of step S21 and step S31.

The determination data DI in step S44, for example, may be changed. As a specific example, the determination data DI may include just part of information regarding position coordinates PC when the vehicle 100 was subjected to the external impact, information regarding the date and time when the vehicle 100 was subjected to the external impact, information regarding the roadway departure of a wheel, and information regarding the impact value GA.

The processing in step S44, for example, may be omitted. As a specific example, the motion manager 45 may end the current determination processing after step S43. Note that even when the processing in step S44 is omitted, determination itself of whether an external impact has been applied to the vehicle 100 can still be executed through the processing in one of step S21 and step S31.

In the above embodiment, the configuration of the vehicle 100 may be changed.

For example, the ECU that realizes the functions of the motion manager 45 may be other than the brake ECU 40. As a specific example, instead of the brake ECU 40, the execution device 11 of the central ECU 10 may realize the functions of the motion manager 45 by executing the motion manager application 45A stored in the storage device 12. That is to say, the central ECU 10, the powertrain ECU 20, the steering ECU 30, the brake ECU 40, and the advanced driver assistance ECU 50 can function as the information processing device.

### Other Technical Ideas

Technical ideas that can be comprehended from the above embodiment and modifications will be described.

### APPENDIX 1

An information processing device executes receiving a requested acceleration as one of motion requests for a vehicle from each of sets of application software, performing arbitration of requested accelerations that are received, outputting an instruction signal to a control device for controlling an actuator of the vehicle based on a target acceleration that is a result of the arbitration of the requested accelerations, acquiring a detection value from an acceleration sensor installed in the vehicle, and performing first determination processing to determine whether an external impact is applied to the vehicle, based on the target acceleration in addition to the detection value.

### APPENDIX 2

The information processing device according to Appendix 1 that is capable of executing acquiring of a vehicle speed that is a speed of the vehicle, and that executes the first determination processing, provided that the vehicle speed is no greater than a stipulated vehicle speed that is set in advance.

### APPENDIX 3

The information processing device according to Appendix 1 or 2 that is capable of executing performing of second determination processing to determine whether the external impact is applied to the vehicle, based on the detection value, regardless of the target acceleration, and that executes the first determination processing on a condition that the actuator is controlled based on the target acceleration, and executes the second determination processing on a condition that the actuator is controlled based on operations by a driver of the vehicle.

### APPENDIX 4

The information processing device according to any one of Appendices 1 to 3 that is capable of executing estimating of a magnitude of an impact applied to the vehicle based on a difference between the detected value and the target acceleration, on a condition that determination is made in the first determination processing that the external impact is applied to the vehicle.

### APPENDIX 5

The information processing device according to any one of Appendices 1 to 4 that is capable of executing notifying a user of the vehicle that the external impact has been applied to the vehicle, on a condition that determination is made in the first determination processing that the external impact has been applied to the vehicle.

### APPENDIX 6

The information processing device according to any one of Appendices 1 to 5 that is capable of executing acquiring of a wheel speed that is a rotational speed of a wheel that the vehicle is equipped with, and making determination based on the wheel speed whether a roadway departure of the wheel occurred, on a condition that determination is made in the first determination processing that the external impact is applied to the vehicle.

### APPENDIX 7

The information processing device according to any one of Appendices 1 to 6 that is capable of executing externally transmitting position information of a point at which the vehicle is situated when the external impact is applied to the vehicle, on a condition that determination is made in the first determination processing that the external impact is applied to the vehicle.

What is claimed is:

1. An information processing device, comprising one or more processors configured to
receive a requested acceleration as one of motion requests for a vehicle from each of sets of application software;
perform arbitration of requested accelerations that are received;
output an instruction signal for controlling an actuator of the vehicle based on a target acceleration that is a result of the arbitration of the requested accelerations;
acquire a detection value from an acceleration sensor installed in the vehicle; and
perform first determination processing to determine whether an external impact is applied to the vehicle, based on the target acceleration in addition to the detection value.

2. The information processing device according to claim 1, wherein the one or more processors are configured to
acquire a vehicle speed that is a speed of the vehicle, and
execute the first determination processing, provided that the vehicle speed is no greater than a stipulated vehicle speed that is set in advance.

3. The information processing device according to claim 1, wherein the one or more processors are configured to
perform second determination processing to determine whether the external impact is applied to the vehicle, based on the detection value, regardless of the target acceleration,
execute the first determination processing on a condition that the actuator is controlled based on the target acceleration, and
execute the second determination processing on a condition that the actuator is controlled based on operations by a driver of the vehicle.

4. The information processing device according to claim 1, wherein the one or more processors are configured to estimate a magnitude of an impact applied to the vehicle based on a difference between the detected value and the target acceleration, on a condition that determination is made in the first determination processing that the external impact is applied to the vehicle.

5. The information processing device according to claim 1, wherein the one or more processors are configured to notify a user of the vehicle that the external impact is applied to the vehicle, on a condition that determination is made in the first determination processing that the external impact is applied to the vehicle.

6. The information processing device according to claim 1, wherein the one or more processors are configured to
acquire a wheel speed that is a rotational speed of a wheel that the vehicle is equipped with, and
make determination based on the wheel speed whether a roadway departure of the wheel occurred, on a condition that determination is made in the first determination processing that the external impact is applied to the vehicle.

7. The information processing device according to claim 1, wherein the one or more processors are configured to externally transmit position information of a point at which the vehicle is situated when the external impact is applied to the vehicle, on a condition that determination is made in the first determination processing that the external impact is applied to the vehicle.

8. A non-transitory storage medium storing instructions that are executable by one or more processors of an information processing device and that cause the one or more processors to perform functions comprising:
receiving a requested acceleration as one of motion requests for a vehicle from each of sets of application software;
performing arbitration of requested accelerations that are received;
outputting an instruction signal for controlling an actuator of the vehicle based on a target acceleration that is a result of the arbitration of the requested accelerations;
acquiring a detection value from an acceleration sensor installed in the vehicle; and
performing first determination processing to determine whether an external impact is applied to the vehicle, based on the target acceleration in addition to the detection value.

9. An information processing method of an information processing device, the information processing method comprising:
receiving a requested acceleration as one of motion requests for a vehicle from each of sets of application software;
performing arbitration of the requested accelerations that are received;
outputting an instruction signal for controlling an actuator of the vehicle based on a target acceleration that is a result of the arbitration of the requested accelerations;
acquiring a detection value from an acceleration sensor installed in the vehicle; and
performing first determination processing to determine whether an external impact is applied to the vehicle, based on the target acceleration in addition to the detection value.
